(19) United States
(12) Patent Application Publication
(10) Pub. No.: US 2011/0154469 A1
(43) Pub. Date: Jun. 23, 2011

(54) METHODS, SYSTEMS, AND COMPUTER PROGRAM PRODUCTS FOR ACCESS CONTROL SERVICES USING SOURCE PORT FILTERING

(75) Inventor: Anthony B. Dargis, Flemington, NJ (US)

(73) Assignee: AT&T Intellectual Property LLP

(21) Appl. No.: 12/640,528

(22) Filed: Dec. 17, 2009

(51) Int. Cl. G06F 17/00

(52) U.S. Cl. 726/11

(57) ABSTRACT

An authentication request message is received at an authentication server computer, the authentication request message identifying a requesting client device. The authentication request message is authenticated at the authentication server computer and, responsive to authentication of the authentication request message, a source port for a redirected communication between the requesting client device associated and the protected server is determined. An access authorization message identifying the determined source port is transmitted from the authentication server computer to a blocking device that controls access to the protected server. A redirect message may be transmitted from the authentication server to a browser resident at the client device responsive to authentication of the authentication request message. Embodiments include methods, apparatus and computer readable media.

### BACKGROUND OF THE INVENTION

The present application relates generally to computer networks and, more particularly, to methods, systems and computer program products for controlling network access.

Private networks, such as networks used by businesses and other entities, are typically connected to public networks, such as the Internet, as such private networks may include servers that provide various retail or other e-commerce services to Internet users. Such internet-connected networks are often subject to attack from unauthorized users. Such attacks may compromise confidential information or consume server resources.

A variety of techniques have been devised for protecting such devices. For example, a device protecting a network may maintain a “whitelist” of internet addresses that are allowed to access the server. However, such whitelists may need to be updated (often manually) as users move from one location to another. Other techniques for protection include “port knocking,” in which a coded sequence of TCP (transmission control protocol) SYN (synchronize) requests to specific ports to authenticate a user, and “single packet authorization” (SPA), in which a specially coded packet authenticates a user and data.

Some access control techniques involve the use of firewalls. Typical firewall devices inspect and filter traffic before making a decision on what to do with a packet. They commonly have two interfaces, an internal interface and an external interface. The external interface may communicate with a router connected to the Internet, while the internal interface may communicate with a local router or private network. Packets received at the external interface are generally passed or rejected according to criteria associated with the firewall. For authorized packets, the firewall typically performs network address translation (NAT) and routes the modified authorized packets towards their destinations. A “transparent” firewall foregoes such routing operations by filtering at the data link layer instead of the network layer, acting like a network bridge rather than a router. Transparent firewalls are also referred to as in-line, shadow, stealth or bridging firewalls.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Some embodiments provide methods of controlling access to a protected server. An authentication request message is received at an authentication server computer, the authentication request message identifying a requesting client device. The authentication request message is authenticated at the authentication server computer and, responsive to authentication of the authentication request message, a source port for a redirected communication between the requesting client device associated and the protected server is determined. An access authorization message identifying the determined source port is transmitted from the authentication server computer to a blocking device that controls access to the protected server.

The methods may also include transmitting a redirect message from the authentication server to a browser resident at the client device responsive to authentication of the authentication request message. Determining the source port for the redirected communication between the requesting client device and the protected server may include predicting the port based on a source port identified in the received authentication request message. The methods may further include controlling access to the protected server via the blocking device responsive to the access authorization message. Some embodiments provide a computer-readable medium having computer code configured to perform such operations.

In additional embodiments, a system includes an authentication server computer configured to receive an authentication request message identifying an authentication requesting client device, to authenticate the authentication request message, to determine a source port for a redirected communication between the requesting client device and the protected server and to transmit an access authorization message identifying the determined source port responsive to authentication of the authentication request message. The system further includes a blocking device configured to receive the access authorization message from authentication server computer and to control access to a protected server responsive to the received access authorization message.

Additional embodiments provide an authentication server including a communications interface circuit configured to receive an authentication request message identifying a requesting client device and an authenticator circuit coupled to the communications interface circuit and configured to authenticate the authentication request message and to determine a source port for a redirected communication between the requesting client device and a protected server. The communications interface circuit is further configured to transmit an access authorization message identifying the determined source port from the authentication server computer to a blocking device that controls access to the protected server responsive to authentication of the authentication request message.

### BRIEF DESCRIPTION OF THE DRAWINGS

Other features of the present invention will be more readily understood from the following detailed description of specific embodiments thereof when read in conjunction with the accompanying drawings, in which:

FIG. 1 is schematic diagram illustrating systems and methods for managing a transparent firewall for network access in accordance with some embodiments;

FIG. 2 is a schematic diagram illustrating an authentication server and blocking device in accordance with some embodiments;

FIG. 3 is a flowchart that illustrates operations methods, systems, and computer program products in accordance with some embodiments.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations discussed herein may be written in a high-level programming language, such as Java, C, and/or C++, for development convenience. In addition, computer program code for carrying out operations according to some embodiments may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Embodiments are described hereinafter with reference to flowchart and/or block diagram illustrations of methods, systems, client devices, and/or computer program products in accordance with some embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

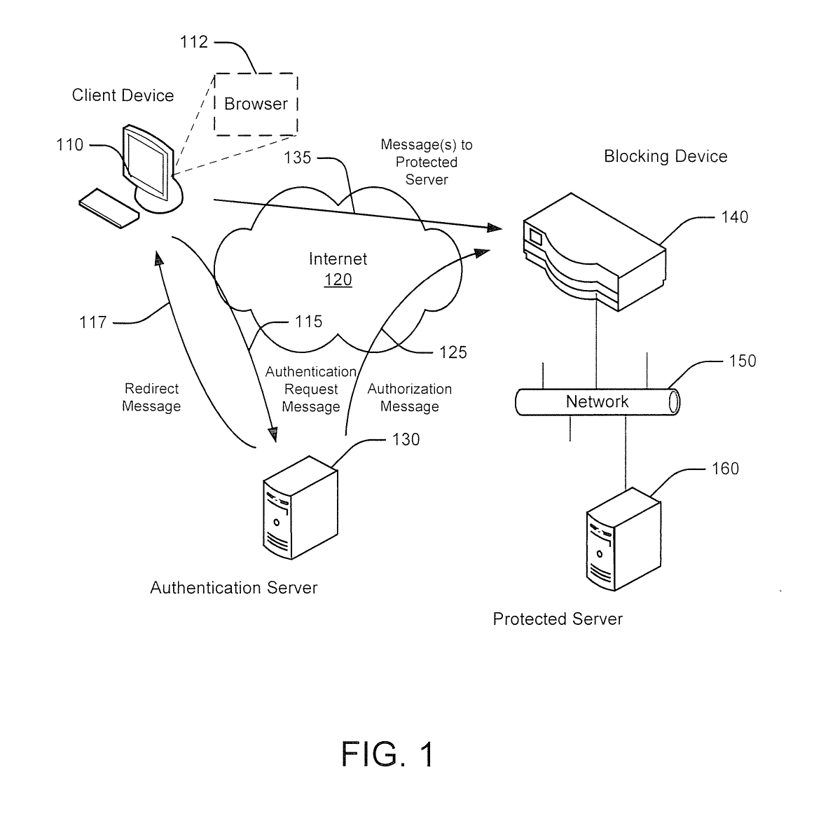

FIG. 1 illustrates access control systems and methods according to some embodiments of the present invention. A blocking device 140 protects a server 160 connected to an internet 120 via a network 150. The blocking device 140 generally controls access to the protected server 160 based on access criteria that may, for example, allow only packets with authorized network (e.g., IP) addresses and port numbers to pass between the internet 120 and the protected server 160. The network 150 may be, for example, a private network of a customer subscribing to protection services provided by a vendor operating the authentication server 130. The blocking device 140 may be a device located, for example, at a customer's premises equipment or a device controlled by a network provider that provides access to the internet 120. The latter configuration may be advantageous for network providers, as it can retain control of security features in the network provider's infrastructure.

An authentication server 130, here shown as connected to the internet 120, is configured to authenticate requests for authorization of access to the protected server 160 and to provide access authorization information to the blocking device 140. In particular, according to some embodiments, the authentication server 130 may be configured to transmit access authorization messages 125 that identify an authorized source address and source port, such that the blocking device 140 may responsively modify the access criteria to allow passage of messages from this address and source port to the protected server 160. In some embodiments, the identified source port is determined based on source port information provided to the authentication server 130 by the client device 110.

For example, a web browser 112 resident at the client device 110 may send an authentication request message 115 to the authentication server 130, seeking access to the protected server 160. The authentication request message 115 may include, for example, a source IP address and source port identification. The source IP address, however, may not be unique to the browser 112. For example, if the client device 110 operates behind a port address translation (PAT) device or a proxy firewall, other clients behind the PAT or firewall device may share the same IP address. Accordingly. IP address alone may be insufficient to prevent unauthorized access by devices having the same shared IP address.

However, for such situations, the authentication server 130 may, upon authorization of the client browser 112, transmit an http redirect message 117 to the client browser 112 to redirect the http session to the protected server 160. The authentication server 130 may predict the new source port for the redirected communication (session), which it may communicate to the blocking device 140. For example, the authentication server 130 may predict that the new source port will be the old source port plus some increment (e.g., one or a small number). The access authorization message 125 transmitted to the blocking device 140 may identify this new source port, which information may be used, for example, to modify and access control list (ACL) maintained at the blocking device 140. In this manner, source port filtering may be used to augment IP address filtering to protect the server 160 from unauthorized messages that share the same source IP address as the authorized client browser 112.

The access authorization message 125 may be, for example, a single Simple Network Management Protocol version 3 (SNMPv3) message that supports authentication, message integrity and encryption of the management payload. The access authorization message 125 may be encrypted and time-stamped to reduce or prevent eavesdropping and replay attacks.

The authentication server 130 may be, for example, a secure socket layer (SSL) enabled web server. Depending on security requirements, examples of authentication processes that may be used include processes involving one-time use of a security token, processes using an ID with password or pass-phrase, processes using a user-entered ID and/or processes using an ID included in an http request string. The authentication server 130 may be configured to handle requests for multiple protected servers and/or networks, and may scale based on the number of servers/networks protected.

The blocking device 140 may be any of a number of different types of network devices, for example, a router with an application blade or a Linux server. In some embodiments, the blocking device 140 may be configured, for example, to provide a transparent firewall. In some embodiments, the network 150 may be a network of a customer of a vendor that operates the authentication server 130. As a service to the customer, the vendor may provide the blocking device 140 to control access to the customer's network 150, which may also have its own internal security structure. The blocking device 140 may, for example, block all traffic that is not specifically authorized by its ACL, while also listening for SNMPv3 access authorization messages 125 from the authentication server 130.

According to further embodiments, the access authorization message 125 may provide additional screening information, for example, information specifying the types of message traffic to be allowed, such as traffic conforming to selected protocols (TCP, UDP, ICMP, ESP, etc.).

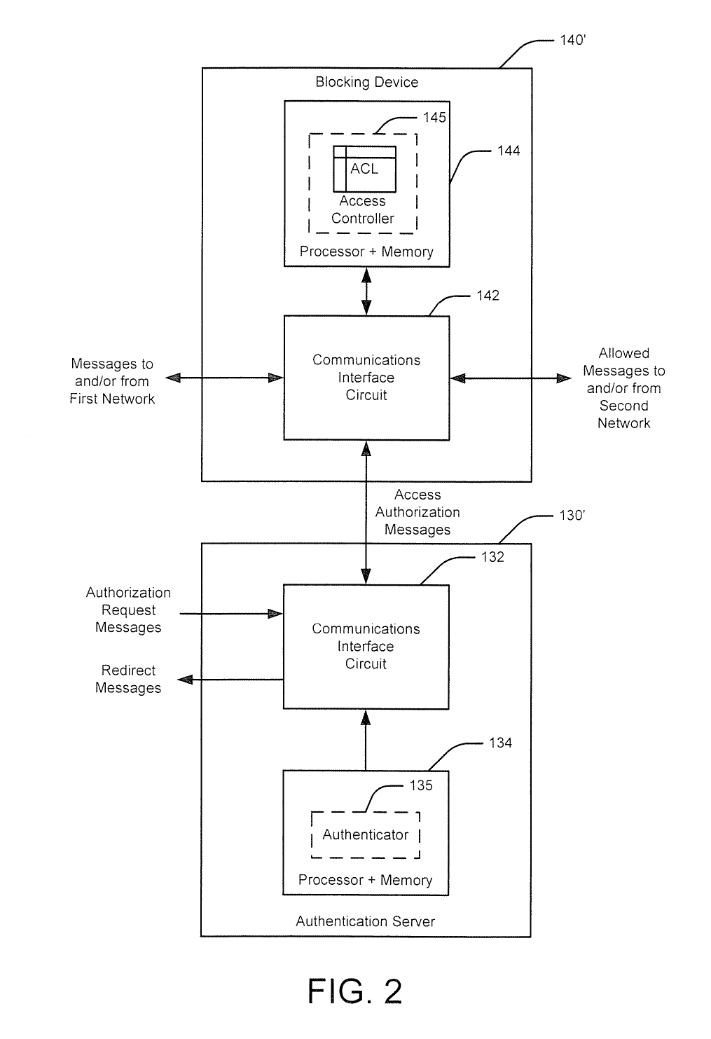

FIG. 2 illustrates implementation of an authentication server 130′ and a blocking device 140′ according to some embodiments. The authentication server 130′ comprises a computer device including a processor and associated memory (internal and/or external) 134, which is configured to send and receive messages via a communications interface circuit 132. Authentication request messages received via the communications interface circuit 132 are authenticated by an authenticator circuit 134, here shown as implemented using program code 135 that is executed by the processor and memory combination 134. The authenticator circuit 134 may, for example, examine source address and source port identification information in a received authentication request message and may responsively determine a new source port and generate an access authorization message identifying the same, which is transmitted to the blocking device 140′ via the communications interface circuit 132. The authenticator circuit 134 may further generate a redirect message that is transmitted to a requesting browser via the communications interface circuit 132, along lines discussed above.

The blocking device 140′ may be a computer device that includes a processor and associated memory 144, which is communicatively coupled to a communications interface circuit 142. The communications interface circuit 142 is configured to receive access authorization messages from the authentication server 130′. As illustrated, the processor and memory 144 is configured to provide an access controller circuit 145 that maintains an ACL based on the received access authorization messages. The communications interface circuit 142 is further configured to receive messages from client devices that are addressed to a server/network protected by the blocking device 140′. The access controller circuit 145 controls transmission of the received messages on to the protected server based on the ACL.

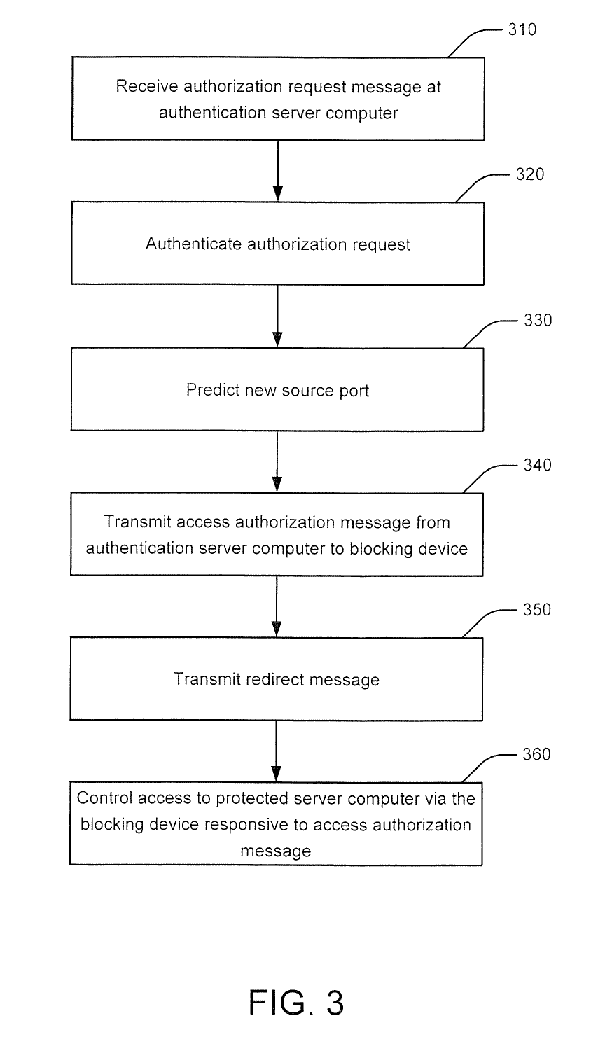

FIG. 3 illustrates operations for controlling access to a protected server according to some embodiments. An authorization request message is received at an authentication server (block 310). In response, the authentication server authenticates the requesting client, predicts a new source port, transmits an authorization message identifying the predicted source port to a blocking device for the protected server and sends a redirect message back to the requesting client to redirect the client browser to the protected server (blocks 320, 330, 340, 350). The receiving blocking device controls access to the protected server responsive to the message, e.g., the blocking device modifies its ACL to allow messages from the identified source address and predicted source port to allow the redirected session to proceed (block 360).

Potential advantages in some embodiments may include allowing the blocking device to be invisible to messages other than those from authorized addresses and messages from the authentication server. Even if the authentication credentials become compromised, the existing security structure of the protected server can detect unauthorized intrusion, and the intrusion's visibility may be enhanced by the filtering effect of the blocking device, which can significantly lower the number of intrusions actually reaching the protected server. Authentication can be moved to the network and performed on a device (the authentication server) that is optimized for the function.

In some embodiments, performance may be enhanced by limiting the number of potential source addresses that may be accepted by a blocking device, as an ACL with an overly large number of authorized source addresses may present performance issues. It may also be desirable to limit the number of applications and hosts, as sites that run multiple applications and/or hosts may be more vulnerable to attack and/or misconfiguration.

Many variations and modifications can be made to the embodiments without substantially departing from the principles of the present invention. All such variations and modifications are intended to be included herein within the scope of the present invention, as set forth in the following claims.

That which is claimed:

1. A method of controlling access to a protected server, the method comprising:
receiving an authentication request message at an authentication server computer, the authentication request message identifying a requesting client device;
authenticating the authentication request message at the authentication server computer; and
responsive to authentication of the authentication request message, determining a source port for a redirected communication between the requesting client device and the protected server and transmitting an access authorization message identifying the determined source port from the authentication server computer to a blocking device that controls access to the protected server.

2. The method of claim 1, wherein determining a source port for a redirected communication between the requesting client device and the protected server comprises predicting the source port for the redirected communication based on a source port identified in the received authentication request message.

3. The method of claim 1, further comprising transmitting a redirect message from the authentication server to a browser resident at the client device responsive to authentication of the authentication request message.

4. The method of claim 1, further comprising controlling access to the protected server via the blocking device responsive to the access authorization message.

5. The method of claim 4, wherein controlling access to the protected server via the blocking device responsive to the access authorization message comprises modifying an access control list (ACL) at the blocking device based on the access authorization message.

6. The method of claim 1, wherein transmitting an access authorization message comprises transmitting a Simple Network Management Protocol version 3 (SNMPv3) message.

7. The method of claim 1, wherein the protected server comprises customer equipment served by network provider infrastructure that comprises the blocking device.

8. A computer-readable medium having computer code configured to perform the method of claim 1 embodied therein.

9. A system comprising:
an authentication server computer configured to receive an authentication request message identifying an authentication requesting client device, to authenticate the authentication request message, to determine a source port for a redirected communication between the requesting client device and the protected server, and to transmit an access authorization message identifying the determined source port responsive to authentication of the authentication request message; and
a blocking device configured to receive the access authorization message from the authentication server computer and to control access to a protected server responsive to the received access authorization message.

10. The system of claim 9, wherein the authentication server computer is configured to predict the source port for the redirected communication based on a source port identified in the received authentication request message.

11. The system of claim 9, wherein the authentication server computer is further configured to transmit a redirect message to a browser resident at the client device responsive to authentication of the authentication request message.

12. The system of claim 9, wherein the blocking device is configured to modify an access control list (ACL) responsive to the access authorization message.

13. The system of claim 9, wherein the access authorization message comprises a SNMPv3 message.

14. The system of claim 9, wherein the protected server comprises customer equipment served by network provider infrastructure that comprises the blocking device.

15. An authentication server comprising:
a communications interface circuit configured to receive an authentication request message identifying a requesting client device; and
an authenticator circuit coupled to the communications interface circuit and configured to authenticate the authentication request message and to determine a source port for a redirected communication between the requesting client device and a protected server,
wherein the communications interface circuit is further configured to transmit an access authorization message identifying the determined source port from the authentication server computer to a blocking device that controls access to the protected server responsive to authentication of the authentication request message.

16. The authentication server of claim 15, wherein the authenticator circuit is configured to predict the source port for the redirected communication based on a source port identified in the received authentication request message.

17. The authentication server of claim 15, wherein the communications interface circuit is further configured to transmit a redirect message from the authentication server to a browser resident at the client device responsive to authentication of the authentication request message.

18. The authentication server of claim 15, wherein the access authorization message comprises a SNMPv3 message.
